(19) United States
(12) Patent Application Publication
(10) Pub. No.: US 2012/0203719 A1
(43) Pub. Date: Aug. 9, 2012

(54) AUDIO SIGNAL PROCESSING DEVICE, AUDIO SIGNAL PROCESSING METHOD, AND PROGRAM

(76) Inventors: Yuhki Mitsufuji, Tokyo (JP); Masayuki Nishiguchi, Kanagawa (JP)

(21) Appl. No.: 13/363,892

(22) Filed: Feb. 1, 2012

(30) Foreign Application Priority Data
Feb. 9, 2011 (JP) 2011-026240

(51) Int. Cl. G06F 15/18

(52) U.S. Cl. 706/12

(57) ABSTRACT

An audio signal processing device includes: a time-frequency analysis unit performing a time-frequency analysis of an input audio signal; a base factorization unit inputting learning data that is generated in advance based on an audio signal for learning including a sound from a plurality of sound sources and is made with base frequencies corresponding to the respective sound sources and carrying out base factorization of a time-frequency analysis result to the input audio signal inputted from the time-frequency analysis unit by applying a total base frequency that has the base frequencies corresponding to the respective sound sources combined therein to generate a base activity to the input audio signal; and a command identification unit inputting the base activity from the base factorization unit to carry out command identification by performing an identification process of the inputted base activity.

### BACKGROUND

The present disclosure relates to an audio signal processing device, an audio signal processing method, and a program. Further in detail, it relates to an audio signal processing device, an audio signal processing method, and a program that perform a process of separating a signal having a plurality of signals mixed therein for each sound source, for example.

The present disclosure relates to a signal processing device, a signal processing method, and a program that, in an environment where sounds from various sound sources, such as a voice and an undesired sound, are inputted by mixture, selects and separates a sound from a particular sound source, such as an audio command corresponding to a voice of a user, for example.

Among recent devices, such as information processing equipment and home appliances, there are those provided with a microphone as an audio input unit, recognizing a voice of a user inputted from the microphone, and performing various behaviors based on a recognition result. That is, they are those interpreting, by analyzing, a word spoken by a user as an audio command to perform a process in accordance with the command.

Although it is requested to carry out accurate audio recognition in a device performing a process by an audio command, a signal turns out to mix noises from various sound sources, other than a voice of a user, to an audio signal to be inputted via the microphone as an audio input unit in an environment of generating various undesired sounds and noises.

In order to extract a voice of a user from such a mixed signal, in many devices, an input signal via the microphone is inputted to a signal processing unit performing a sound source separation process to carry out a process of separating a voice of a user. After that, command interpretation is carried out based on the voice of a user that is separated for extraction.

As a related art disclosing a sound source separation process, there are Japanese Unexamined Patent Application Publication No. 2006-238409 and Japanese Unexamined Patent Application Publication No. 2008-134298, for example. These patent documents disclose sound source separation processes based on an independent component analysis (ICA).

However, there is a problem in the sound source separation process that a simple configuration is insufficient for a separation processing function, and a problem that the processing load and the processing time increase for a high separation function and thus the costs as a device also increases. In order to be provided in a general home appliance or the like, the processing load and the costs are demanded to be suppressed lower. In addition, since a sound source separation process in the past has independently had a separation process at an earlier stage and a recognition process at a later stage as separated module, there has been a problem that carrying out overall optimization has been difficult, such as carrying out a separation process using information of a feature amount desired for recognition.

### SUMMARY

It is desirable to provide an audio signal processing device, an audio signal processing method, and a program that are enabled with a simple configuration and also to carry out overall optimization and enable sound source separation of higher accuracy.

An embodiment of the present disclosure is an audio signal processing device including: a time-frequency analysis unit performing a time-frequency analysis of an input audio signal; a base factorization unit inputting learning data that is generated in advance based on an audio signal for learning including a sound from a plurality of sound sources and is made with base frequencies corresponding to the respective sound sources and carrying out base factorization of a time-frequency analysis result to the input audio signal inputted from the time-frequency analysis unit by applying a total base frequency that has the base frequencies corresponding to the respective sound sources combined therein to generate a base activity to the input audio signal; and a command identification unit inputting the base activity from the base factorization unit to carry out command identification by performing an identification process of the inputted base activity.

Further, in an audio signal processing device of an embodiment of the present disclosure, the learning data is learning data generated based on the audio signal for learning including a target sound with a base frequency corresponding to a sound to be identified as the command and a non-target sound not subjected to identification, and the base factorization unit carries out the base factorization of the time-frequency analysis result to the input audio signal inputted from the time-frequency analysis unit by applying the total base frequency that has the base frequency corresponding to the target sound and a base frequency corresponding to the non-target sound combined therein to generate the base activity to the input audio signal.

Further, in an audio signal processing device of an embodiment of the present disclosure, the time-frequency analysis unit carries out the time-frequency analysis of the input audio signal, generates a time-frequency spectrum, and further calculates a power spectrum based on the time-frequency spectrum to provide the power spectrum to the base factorization unit as the time-frequency analysis result.

Further, in an audio signal processing device of an embodiment of the present disclosure, the base factorization unit inputs the power spectrum generated based on the input audio signal from the time-frequency analysis unit and carries out the base factorization by applying the total base frequency to the inputted power spectrum to generate the base activity to the input audio signal.

Further, in an audio signal processing device of an embodiment of the present disclosure, the command identification unit performs a process of inputting the base activity from the base factorization unit and determining the command and a non-command by carrying out a comparison process between the inputted base activity and a threshold set in advance.

Further, in an audio signal processing device of an embodiment of the present disclosure, the audio signal processing device has a learning process unit generating the learning data made with the base frequencies corresponding to the respective sound sources based on the audio signal for learning including the sound from the plurality of sound sources, and the base factorization unit generates the base activity of the input audio signal by applying the learning data generated by the learning process unit.

Further, another embodiment of the present disclosure is an audio signal processing device, including: a learning process unit calculating a feature amount in advance desired for positive or negative determination of an audio command; and an analysis processing unit carrying out a sound source separation process using the feature amount learned in the learning process unit.

Further, in an audio signal processing device of an embodiment of the present disclosure, the feature amount desired for the positive or negative determination of the audio command calculated in the learning process unit is a feature amount desired for a positive or negative determination process, which is a process of discriminating a target sound corresponding to the audio command executed in an audio command recognition process in the analysis processing unit from a non-target sound not corresponding to the audio command.

Further, still another embodiment of the present disclosure is an audio signal processing method carrying out a command identification process from an input audio signal in an audio signal processing device, the method including: time-frequency analyzing by a time-frequency analysis unit performing a time-frequency analysis of an input audio signal; base factorizing by a base factorization unit inputting learning data that is generated in advance based on an audio signal for learning including a sound from a plurality of sound sources and is made with base frequencies corresponding to the respective sound sources and carrying out base factorization of a time-frequency analysis result to the input audio signal inputted from the time-frequency analysis unit by applying a total base frequency that has the base frequencies corresponding to the respective sound sources combined therein to generate a base activity to the input audio signal; and command identifying by a command identification unit inputting the base activity generated in the base factorizing to carry out command identification by performing an identification process of the inputted base activity.

Further, yet another embodiment of the present disclosure is an audio signal processing method carrying out a command identification process from an input audio signal in an audio signal processing device, the method including: learning processing by a learning process unit calculating a feature amount in advance desired for positive or negative determination of an audio command; and analysis processing by an analysis processing unit carrying out a sound source separation process using the feature amount learned in the learning processing.

Further, yet another embodiment of the present disclosure is a program causing a command identification process from an input audio signal to be executed in an audio signal processing device, the program including: time-frequency analyzing causing a time-frequency analysis unit to perform a time-frequency analysis of an input audio signal; base factorizing causing a base factorization unit to input learning data that is generated in advance based on an audio signal for learning including a sound from a plurality of sound sources and is made with base frequencies corresponding to the respective sound sources and to carry out base factorization of a time-frequency analysis result to the input audio signal inputted from the time-frequency analysis unit by applying a total base frequency that has the base frequencies corresponding to the respective sound sources combined therein to generate a base activity to the input audio signal; and command identifying causing a command identification unit to input the base activity generated in the base factorizing to carry out command identification by performing an identification process of the inputted base activity.

The program of an embodiment of the present disclosure is a program capable of being provided by a storage medium or a communication medium provided in a computer readable format to, for example, an image processing device or a computer system capable of executing various program codes. Providing such a program in a computer readable format enables a process appropriate for the program on an information processing device or a computer system.

Still other intentions, characteristics, and advantages of embodiments of the present disclosure will be apparent from a more detailed description based on embodiments of the present disclosure described later and the appended drawings. A system in this specification is a logical collective configuration of a plurality of devices, and it is not limited to those having each configuration device in an identical housing.

A configuration of an embodiment of the present disclosure enables a device and a method highly accurately separating a command of a particular sound source from an audio signal having a plurality of sounds mixed therein. Specifically, for example, learning data made with a base frequency corresponding to each sound source is generated on the basis of an audio signal for learning including sounds from a plurality of sound sources to generate a total base frequency having the base frequencies, corresponding to the respective sound sources, combined therein. Further, a time-frequency analysis is performed to an input audio signal to generate a time-frequency analysis result. Base factorization to which the total base frequency is applied is carried out to the time-frequency analysis result to this input audio signal to generate a base activity to the input audio signal. Finally, an identification process of the generated base activity is performed to carry out command identification.

The sound source separation process based on the learning data enables highly accurate command identification.

### BRIEF DESCRIPTION OF THE DRAWINGS

FIG. 1 illustrates a configuration example of an audio signal processing device;

FIG. 2 illustrates a time-frequency analysis process performed in a time-frequency analysis unit;

FIG. 3 illustrates a process example of factorizing one matrix into two matrices; and

FIG. 4 illustrates an example of using by, after learning a base in a learning process unit in the upper half shown in FIG. 1, combining the learned base in an analysis processing unit in the lower half.

### DETAILED DESCRIPTION OF EMBODIMENTS

Below is a detailed description of an audio signal processing device, an audio signal processing method, and a program of embodiments of the present disclosure with reference to the drawings. The description is given in accordance with the following subtitles.
1. Regarding Entire Configuration of Audio Signal Processing Device
2. Regarding Process in Each Configuration Unit of Audio Signal Processing Device
   2.1. Regarding Time-Frequency Analysis Unit
   2.2. Regarding Base Learning Unit
   2.3. Regarding Base Factorization Unit
   2.4. Regarding Command Identification Unit

[1. Regarding Entire Configuration of Audio Signal Processing Device]

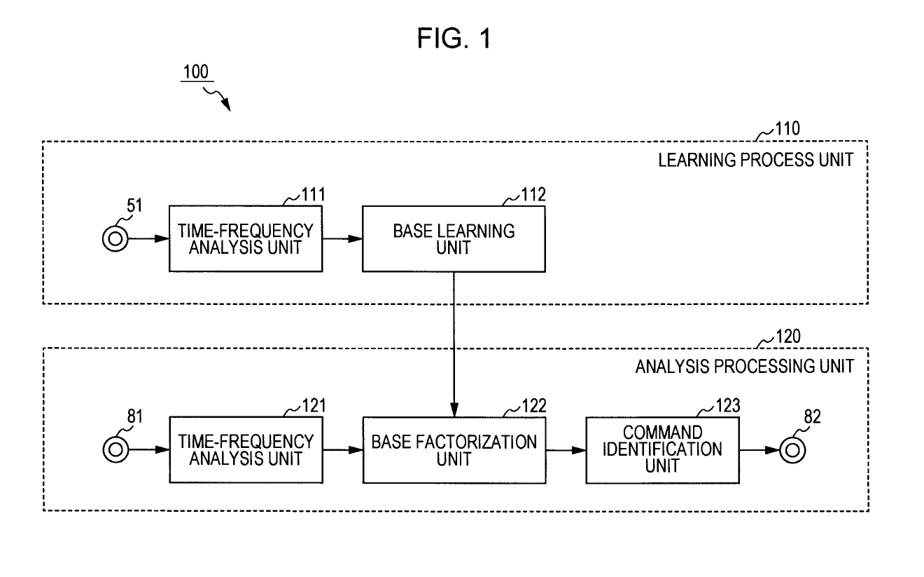

Firstly, a description is given to an entire configuration of an audio signal processing device according to an embodiment of the present disclosure with reference to FIG. 1.

FIG. 1 illustrates an example of an audio signal processing device 100 according to an embodiment of the present disclosure. The audio signal processing device 100 shown in FIG. 1 is a device inputting a word of a user to perform a recognition process of an audio command, which is a demand to the device, from the word of a user.

The audio signal processing device 100 shown in FIG. 1 has a configuration provided with a learning process unit 110 that calculates a feature amount in advance desired for positive or negative determination of an audio command and an analysis processing unit 120 that carries out a sound source separation process using a feature amount learned in the learning process unit 110. The feature amount desired for positive or negative determination of an audio command calculated in the learning process unit 110 is, for example, a feature amount desired for a positive or negative determination process, which is a process of discriminating a target sound corresponding to an audio command to be executed in an audio command recognition process in the analysis processing unit 120 from a non-target sound not corresponding to the audio command.

As shown in FIG. 1, the audio signal processing device 100 has a learning process unit 110 in the upper half and an analysis processing unit 120 in the lower half.

The learning process unit 110 in the upper half carries out base learning of a target sound and a non-target sound in a feature amount space in advance to provide the learning result as learning data to the analysis processing unit 120.

Utilizing the base learning result of a target sound and a non-target sound in a feature amount space provided from the learning process unit 110, the analysis processing unit 120 inputs a sound including a voice of a user to be actually subjected to an analysis and separates the targeted voice of a user from the input sound to carry out a command identification process based on the separation result.

As shown in FIG. 1, the learning process unit 110 has a time-frequency analysis unit 111 and a base learning unit 112.

The analysis processing unit 120 also has a time-frequency analysis unit 121, a base factorization unit 122, and a command identification unit 123.

An outline of a process in the learning process unit 110 and a process in the analysis processing unit 120 is described.

The learning process unit 110 inputs an audio signal 51 for learning made with a target sound and a non-target sound to carry out a time-frequency analysis in the time-frequency analysis unit 111 to the audio signal 51 for learning. Further, the base learning unit 112 performs a learning process using the time-frequency analysis result to generate a base frequency B1(k, p), which is an element of a base frequency matrix W1 of a target sound, and a base frequency B2(k, p), which is an element of a base frequency matrix W2 of a non-target sound as the learning result. They are provided to the analysis processing unit 120 as the learning data.

The analysis processing unit 120 inputs an input audio signal 81 including a voice of a user (=target sound) including a command to be subjected to an extraction and a noise (=non-target sound). The time-frequency analysis unit 121 performs a time-frequency analysis to the input audio signal 81 to provide an analysis result to the base factorization unit 122.

The base factorization unit 122 carries out base factorization by applying the time-frequency analysis result inputted from the time-frequency analysis unit 121 and the learning data inputted from the base learning unit 112 of the learning process unit 110, that is, base frequency data corresponding to a target sound and a non-target sound to obtain a base activity H(p, l).

Further, the command identification unit 123 carries out an identification process to the base activity H(p, l) supplied from the base factorization unit 122 to acquire a command 82. The command 82 as an identification result is provided to a data processing unit in the next stage to perform data processing based on the command.

The following describes details of a process in each configuration unit.

[2. Regarding Process in Each Configuration Unit of Audio Signal Processing Device]

(2.1. Regarding Time-Frequency Analysis Unit)

As shown in FIG. 1, the time-frequency analysis units are set in processing units of both the learning process unit 110 and the analysis processing unit 120.

The time-frequency analysis unit 111 in the learning process unit 110 shown in FIG. 1 inputs the audio signal 51 for learning made with a target sound and a non-target sound to carry out a time-frequency analysis to the audio signal 51 for learning.

The time-frequency analysis unit 121 in the analysis processing unit 120 carries out a time-frequency analysis to the input audio signal 81 including a voice of a user (=target sound) including a command to be subjected to an extraction and a noise (=non-target sound) other than the voice of a user not to be subjected to a command extraction.

The audio signal 51 for learning inputted to be subjected to learning in the learning process unit 110 is preferably set in an audio signal including a voice of a user (=target sound) similar to the audio signal inputted by the analysis processing unit 120 and a noise (=non-target sound) other than the voice of a user.

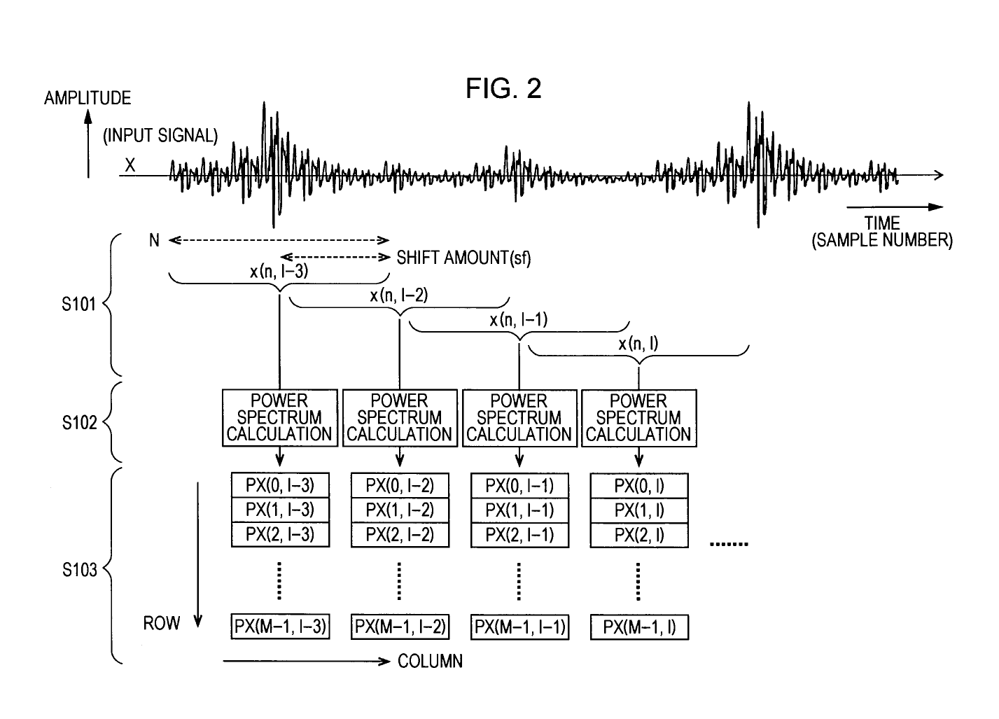

The time-frequency analysis process performed in the time-frequency analysis unit 111 of the learning process unit 110 and the time-frequency analysis unit 121 of the analysis processing unit 120 is described with reference to FIG. 2.

The time-frequency analysis unit 111 and the time-frequency analysis unit 121 analyze time-frequency information of an inputted audio signal.

An input signal inputted via a microphone or the like is assumed to be x. The uppermost part of FIG. 2 shows an example of the input signal x. The horizontal axis is the time (or a sample number), and the vertical axis is the amplitude.

The input signal x is a signal having sounds from various sound sources mixed therein.

An input signal x to the time-frequency analysis unit 111 in the learning process unit 110 is the audio signal 51 for learning made with a target sound and a non-target sound.

An input signal x to the time-frequency analysis unit 121 in the analysis processing unit 120 is the input audio signal 81 including a voice of a user (=target sound) including a command to be subjected to an extraction and a noise (=non-target sound).

Firstly, frame division of a fixed size from the input signal x is carried out to obtain an input frame signal x(n, l).

It is a process of step S101 in FIG. 2.

In the example shown in FIG. 2, the size of the frame division is N and a shift amount (sf) of each frame is 50% of the size N of the frames for a setting of overlapping each frame.

Further, a predetermined window function w is multiplied to the input frame signal x(n, l) to obtain a window function applied signal wx(n, l). As the window function, a Hamming window, for example, is applicable.

The window function applied signal wx(n, l) is expressed by Expression 1 below.

$$wx ( n , l ) = w ( n ) * x ( n , l ) ( \begin{matrix}x \text{:} input signal \\ n \text{:} time index \\ l \text{:} frame number \\ w \text{:} window function \\ wx \text{:} window function applied signal\end{matrix} ) \\ w ( n ) = 0.54 - 0.46 * cos ( 2 π \frac{n}{N} ) ( N \text{:} size of a frame ) \qquad ( 1 )$$

In Expression 1 above,
x: input signal,
n: time index, n=0, N−1, l=0, L−1
   (N being a size of a frame)
l: frame number, l=0, L−1
   (L being the total frame number)
w: window function, and
wx: window function applied signal.

As the window function w, other than a Hamming window, other window functions, such as a Hanning window and a Blackman-Harris window, can also be used.

The size N of a frame is, for example, a sample number equivalent to 0.02 sec (N=sampling frequency fs*0.02). It may also be a size other than that.

Although the shift amount (sf) of a frame is 50% of the size (N) of a frame for a setting of overlapping each frame in the example shown in FIG. 2, it may also be a shift amount other than that.

A time-frequency analysis is carried out in accordance with Expression 2 shown below to the window function applied signal wx(n, l) obtained in accordance with Expression 1 above to obtain a time-frequency spectrum X(k, l).

$$X ( k , l ) = {\sum }_{n = 0}^{M - 1} wx ( n , l ) * exp ( - j2π \frac{k * n}{M} ) ( \begin{matrix}wx \text{:} window function applied signal \\ j \text{:} pure imaginary number \\ M \text{:} point number of DFT \\ k \text{:} frequency index \\ X \text{:} time \text{-} frequency spectrum\end{matrix} ) \\ wx ( n , l ) = \{ \begin{matrix}wx ( n , l ) & n = 0 , … , N - 1 \\ 0 & n = N , … , M - 1\end{matrix} \qquad ( 2 )$$

In Expression 2 above,
wx: window function applied signal,
j: pure imaginary number,
M: point number of DFT (discrete Fourier transform),
k: frequency index, and
X: time-frequency spectrum.

As the time-frequency analysis process to a window function applied signal wx(n, l), a frequency analysis by DFT (discrete Fourier transform) is applied, for example. Other than that, other frequency analyses may also be used, such as DCT (discrete cosine transform) and MDCT (modified discrete cosine transform). If desired, zero padding may also be carried out appropriately in conformity to the point number M of DFT (discrete Fourier transform). Although the point number M of DFT is described as a value of an N or more power of 2, it may also be a point number other than that.

Next, from the time-frequency spectrum X(k, l) obtained in accordance with Expression 2 above, a power spectrum PX(k, l) is obtained in accordance with Expression 3 shown below.

$$PX ( k , l ) = X ( k , l ) * conj ( X ( k , l ) ) ( \begin{matrix}X \text{:} time \text{-} frequency spectrum \\ conj \text{:} complex conjugate \\ PX \text{:} power spectrum\end{matrix} ) \qquad ( 3 )$$

In Expression 3 above,
X: time-frequency spectrum,
conj: complex conjugate, and
PX: power spectrum.

This process corresponds to a process of step S102 shown in FIG. 2.

The input signal x to the time-frequency analysis unit 111 in the learning process unit 110 shown in FIG. 1 is the audio signal 51 for learning made with a target sound and a non-target sound. The time-frequency analysis unit 111 in the learning process unit 110 supplies a power spectrum PX(k, l) obtained as a time-frequency analysis result to the audio signal 51 for learning made with a target sound and a non-target sound to the base learning unit 112.

The input signal x to the time-frequency analysis unit 121 in the analysis processing unit 120 is the input audio signal 81 including a voice of a user (=target sound) including a command to be subjected to an extraction and a noise (=non-target sound). The time-frequency analysis unit 121 in the analysis processing unit 120 supplies a power spectrum PX(k, l) obtained as a time-frequency analysis result to the input audio signal 81 including a voice of a user (=target sound) including the command to be subjected to an extraction and a noise (=non-target sound) to the base factorization unit 122.

Step S103 shown in FIG. 2 illustrates elements of a matrix in a case of representing the power spectrum PX(k, l) calculated for each frame as a matrix.

It shows each element of the matrix as a matrix of M rows and L columns, with
a frequency (frequency bin) in a row and
a time (frame) in a column.

(2.2. Regarding Base Learning Unit)

As described above, the input signal x to the time-frequency analysis unit 111 in the learning process unit 110 shown in FIG. 1 is the audio signal 51 for learning made with a target sound and a non-target sound. The time-frequency analysis unit 111 in the learning process unit 110 supplies a power spectrum PX(k, l) obtained as a time-frequency analysis result to the audio signal 51 for learning made with a target sound and a non-target sound as learning data to the base learning unit 112.

In the base learning unit 112, the power spectrum PX(k, l) supplied from the time-frequency analysis unit 111 is considered as a matrix of M rows and L columns and it is factorized into new two matrices.

The matrix of M rows and L columns is a matrix shown in step S103 shown in FIG. 2.

The base learning unit 112 factorizes the power spectrum PX(k, l) in a format of this matrix of M rows and L columns into new two matrices.

To the matrix factorization, NMF (non-negative matrix factorization) is applied, for example.

Where a factorization number is P, a base frequency B(k, p) of a base number P and a base activity H(p, l) of the base number P corresponding to each of them are obtained.

p denotes a base index and p=0, P−1.

In a case of the embodiment,
the base frequency B(k, p) shows a property in a frequency direction of the power spectrum PX(k, l) indicating the time-frequency information of the input signal, and
the base activity H(p, l) shows a property in a time direction.

By assuming the factorization number to the input signal x as P and minimizing an error function E defined by Expression 4 below, the base frequency B(k, p) and the base activity H(p, l) are obtained.

$$PX ( k , l ) = X ( k , l ) * conj ( X ( k , l ) ) ( \begin{matrix}X \text{:} time \text{-} frequency spectrum \\ conj \text{:} complex conjugate \\ PX \text{:} power spectrum\end{matrix} ) \qquad ( 4 )$$

In Expression 4 above,
E: error function,
V: power spectrum matrix,
W: base frequency matrix, and
H: base activity matrix.

The power spectrum PX(k, l) corresponds to a matrix V of K rows and L columns as shown in FIG. 2 (S103).

The base frequency B(k, p) is represented by a matrix W of K rows and P columns, and

the base activity H(p, l) is by a matrix H of P rows and L columns.

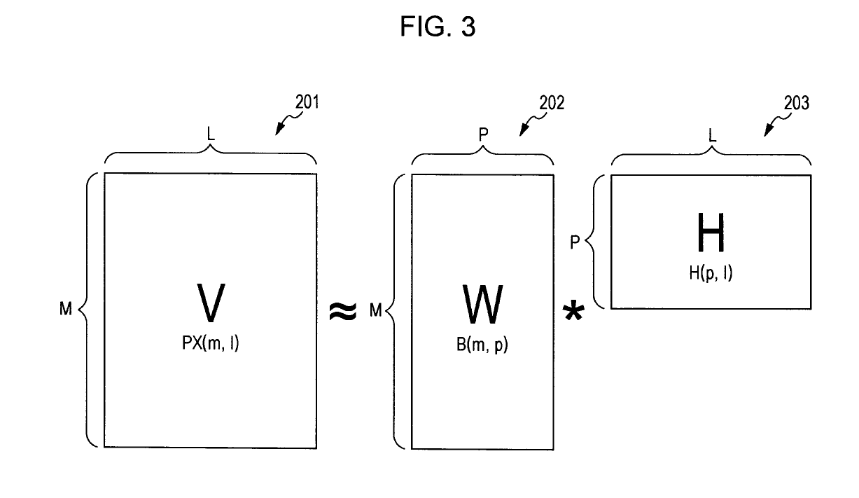

The process of factorizing one matrix into two matrices is described with reference to FIG. 3.

The example shown in FIG. 3 illustrates an example of factorizing
one matrix V201 of M rows and L columns showing the power spectrum PX(k, l) into
these two matrices of
a matrix W202 of M rows and P columns showing the base frequency B(k, p) and
a matrix H203 of P rows and L columns showing the base activity H(p, l).

By minimizing the error function E expressed by Expression 4 above by a gradient method, update formulas shown in Expression 5 below are obtained.

$${W}_{kp} ← {W}_{kp} \frac{{( V * {H}^{T} )}_{kp}}{{( W * H * {H}^{T} )}_{kp}} \\ {H}_{pl} ← {H}_{pl} \frac{{( {W}^{T} * V )}_{pl}}{{( {W}^{T} * W * H )}_{pl}} \qquad ( 5 )$$

In a case of minimizing the error function E expressed by Expression 4 above by a gradient method, a Euclidean distance is used for calculation of a difference between a prediction result and an observation result, for example. Other than that, the KL-divergence, other distances, and the like can also be utilized.

The base learning unit 112 supplies the base frequency B(k, p), which is an element of the base frequency matrix W obtained by the process described above, to the base factorization unit 122 in the analysis processing unit 120.

That is, in the learning process unit 110 shown in FIG. 1, firstly, the time-frequency analysis unit 111 performs a time-frequency analysis to the audio signal 51 for learning made with a target sound and a non-target sound to generate a power spectrum PX(k, l) as the time-frequency analysis result.

Next, the base learning unit 112 calculates a base frequency B(k, p), which is an element of the base frequency matrix W, by the update formulas shown in Expression 5 above based on the power spectrum PX(k, l), which is the time-frequency analysis result to the audio signal 51 for learning made with a target sound and a non-target sound to supply the calculated base frequency B(k, p) to the base factorization unit 122 in the analysis processing unit 120.

The base frequency B(k, p) calculated by the base learning unit 112 is
(1) the base frequency B1(k, p), which is an element of the base frequency matrix W1 of the target sound and
(2) the base frequency B2(k, p), which is an element of the base frequency matrix W2 of the non-target sound.

In such a manner, the learning process unit 110 shown in FIG. 1 generates the base frequency B1(k, p), which is an element of the base frequency matrix W1 of the target sound, and the base frequency B2(k, p), which is an element of the base frequency matrix W2 of the non-target sound as learning data based on the audio signal 51 for learning to provide them to the analysis processing unit 120.

A value of the base number P does not have to be same for each sound source and may also be changed appropriately.

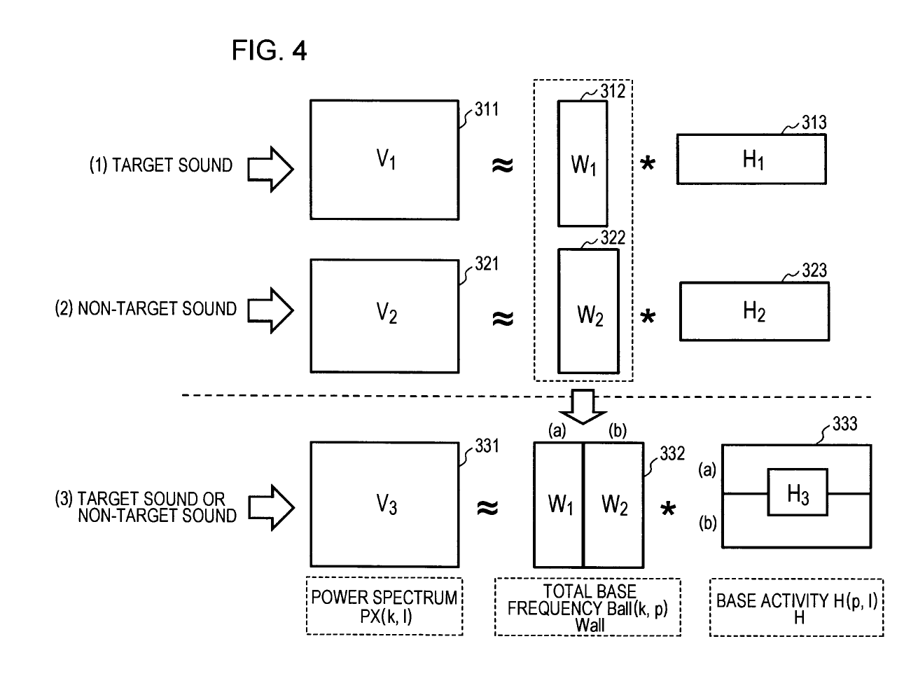

FIG. 4 illustrates a concept of, after learning a base in the learning process unit 110 in the upper half shown in FIG. 1, using the learned base in the analysis processing unit 120 in the lower half in combination.

The examples shown in FIG. 4 show the followings.
(1) A factorization examples of, regarding the target sound,
one matrix V_1, 311 showing a power spectrum PX into the two matrices of
a matrix W_1, 312 showing the base frequency B(k, p) and
a matrix H_1, 313 showing the base activity H(p, l).

(2) A factorization examples of, regarding the non-target sound,
one matrix V_2, 321 showing the power spectrum PX into the two matrices of
a matrix W_2, 322 showing the base frequency B(k, p) and
a matrix H_2, 323 showing the base activity H(p, l).

(3) A factorization examples of, regarding a mixed signal of the target sound and the non-target sound,
one matrix V_3, 331 showing the power spectrum PX into the two matrices of
a matrix W_3, 332 showing the base frequency B(k, p) and
a matrix H_3, 333 showing the base activity H(p, l).

By the base learning in the learning process unit 110 in the upper half shown in FIG. 1, data of (1) and (2) in FIG. 4 is generated.

The base factorization unit 122 in the analysis processing unit 120 in the lower half carries out separation by applying the data of (1) and (2) of FIG. 4 of the matrix W_3, 332 showing the base frequency B(k, p) and the matrix H_3, 333 showing the base activity H(p, l) obtained from one matrix V_3, 331 showing the power spectrum PX obtained from the mixed signal of the target sound and the non-target sound shown in (3) of FIG. 4 into a matrix (a) corresponding to the target sound and a matrix (b) corresponding to the non-target sound.

(2.3. Regarding Base Factorization Unit)

Next, a process of the base factorization unit 122 in the analysis processing unit 120 shown in FIG. 1 is described.

The base factorization unit 122 inputs the power spectrum PX(k, l) generated by the time-frequency analysis to the input audio signal 81 in the time-frequency analysis unit 121 at the earlier stage.

Further, the base factorization unit 122 inputs the base frequencies B(k, p) of various learned sound sources from the base learning unit 112 in the learning process unit 110.

Based on the individual base frequencies B(k, p) of the various learned sound sources, the base factorization unit 122 generates a total base frequency Ball(k, p) having them combined therein from the base learning unit 112 in the learning process unit 110.

This process is equivalent to the process of (3) shown in FIG. 4.

The base factorization unit 122 carries out base factorization using the total base frequency Ball(k, p) having individual base frequencies B(k, p) combined therein to obtain the base activity H(p, l). It should be noted that p=0, . . . , P_all-1. P_all is a sum of the number of the base number P determined for each of the various sound sources.

The power spectrum PX(k, l) is represented by a matrix V of K rows and L columns, the total base frequency Ball(k, p) is represented by a matrix Wall of K rows and P_all columns, and the base activity H(p, l) is represented by a matrix H of P_all rows and L columns.

As shown in FIG. 4, since the total base frequency Ball(k, p) is already learned in the learning process unit 110, an update by a gradient method is not carried out and only the base activity H(p, l) is updated.

The update process of the base activity H(p, l) is carried out in accordance with Expression 6 below.

$${H}_{pl} ← {H}_{pl} \frac{{( {W}_{all}^{T} * V )}_{pl}}{{( {W}_{all}^{T} * {W}_{all}^{T} * H )}_{pl}} \qquad ( 6 )$$

The base activity H(p, l) calculated by the base factorization unit 122 is supplied from the base factorization unit 122 to the command identification unit 123.

(2.4. Regarding Command Identification Unit)

Next, a process of the command identification unit 123 in the analysis processing unit 120 shown in FIG. 1 is described.

In the command identification unit 123, an identification process is carried out to the base activity H(p, l) supplied from the base factorization unit 122 to obtain a command result. For example, in accordance with Expression 7 below, a threshold comparison is performed to obtain a command result.

$${\prod }_{p = 0}^{P\_ all - 1} ( H ( p , l ) \geq Thre ( p , l ) ) = \{ \begin{matrix}1 , & command \\ 0 , & non \text{-} command\end{matrix} ( Thre \text{:} threshold for each base ) \qquad ( 7 )$$

Although Expression 7 above carries out a process of determining a command and a non-command by carrying out a comparison process with a threshold set in advance, it is not limited to this method and nonlinear identification associated with an activating function, such as generalized linear discrimination, for example, may also be carried out. In addition, although the result of the threshold process in Expression 7 is AND operated, other logical operations, such as an OR operation, may also be applied.

The command identification unit 123 makes the command information obtained by the determination process of Expression 7 above to be a command output 82 shown in FIG. 1.

This command output 82 is inputted to, for example, a data processing unit that performs data processing appropriate for the command to perform various processes in accordance with the command.

Although a description is given to a configuration example of the audio signal processing device 100 shown in FIG. 1 having two processing units of the learning process unit 110 and the analysis processing unit 120 in the embodiment above, the configuration may also save the learning data obtained as a learning result of the learning process unit 110 in a storage unit in advance. That is, the learning data saved in a storage unit may also be in a configuration of being acquired as desired by the analysis processing unit 120 to carry out a process to an input signal. In a case of this configuration, an audio signal processing device is possible to be configured with an analysis processing unit from which a learning process unit is omitted and a storage unit that saves learning data as a learning result.

Embodiments of the present disclosure have been described in detail above with reference to particular embodiments. However, it is apparent that those skilled in the art can modify and substitute the embodiments without departing from the spirit of the embodiments of the present disclosure. That is, the embodiments of the present disclosure have been disclosed in the form of exemplification and should not be interpreted in a limited manner. The substance of the present disclosure should be judged according to the embodiments of the present disclosure.

The series of processes described in this specification is possible to be performed by hardware, software, or a composite configuration of both. In a case of performing the process by software, a program having a process sequence recorded therein is possible to be installed in a memory in a computer built in dedicated hardware for execution, or a program is possible to be installed in a general purpose computer capable of performing various types of processes for execution. For example, the program can be recorded in a recording medium in advance. Other than installed from a recording medium to a computer, a program can be received via a network, like a LAN (local area network) and the Internet, to be installed in a recording medium, such as a built-in hard disk.

The various types of processes described in this specification are not only performed sequentially in accordance with the description but may also be performed in parallel or individually depending on the throughput of the device to perform the processes or as desired. In this specification, a system is a logical collective configuration of a plurality of devices, and it is not limited to those having each configuration device in an identical housing.

The present disclosure contains subject matter related to that disclosed in Japanese Priority Patent Application JP 2011-026240 filed in the Japan Patent Office on Feb. 9, 2011, the entire contents of which are hereby incorporated by reference.

What is claimed is:

1. An audio signal processing device comprising:
a time-frequency analysis unit performing a time-frequency analysis of an input audio signal;
a base factorization unit inputting learning data that is generated in advance based on an audio signal for learning including a sound from a plurality of sound sources and is made with base frequencies corresponding to the respective sound sources and carrying out base factorization of a time-frequency analysis result to the input audio signal inputted from the time-frequency analysis unit by applying a total base frequency that has the base frequencies corresponding to the respective sound sources combined therein to generate a base activity to the input audio signal; and
a command identification unit inputting the base activity from the base factorization unit to carry out command identification by performing an identification process of the inputted base activity.

2. The audio signal processing device according to claim 1, wherein
the learning data is learning data generated based on the audio signal for learning including a target sound with a base frequency corresponding to a sound to be identified as the command and a non-target sound not subjected to identification, and
the base factorization unit carries out the base factorization of the time-frequency analysis result to the input audio signal inputted from the time-frequency analysis unit by applying the total base frequency that has the base frequency corresponding to the target sound and a base frequency corresponding to the non-target sound combined therein to generate the base activity to the input audio signal.

3. The audio signal processing device according to claim 1, wherein the time-frequency analysis unit carries out the time-frequency analysis of the input audio signal, generates a time-frequency spectrum, and further calculates a power spectrum based on the time-frequency spectrum to provide the power spectrum to the base factorization unit as the time-frequency analysis result.

4. The audio signal processing device according to claim 3, wherein the base factorization unit inputs the power spectrum generated based on the input audio signal from the time-frequency analysis unit and carries out the base factorization by applying the total base frequency to the inputted power spectrum to generate the base activity to the input audio signal.

5. The audio signal processing device according to claim 1, wherein the command identification unit performs a process of inputting the base activity from the base factorization unit and determining the command and a non-command by carrying out a comparison process between the inputted base activity and a threshold set in advance.

6. The audio signal processing device according to claim 1, wherein
the audio signal processing device has a learning process unit generating the learning data made with the base frequencies corresponding to the respective sound sources based on the audio signal for learning including the sound from the plurality of sound sources, and
the base factorization unit generates the base activity of the input audio signal by applying the learning data generated by the learning process unit.

7. An audio signal processing device, comprising:
a learning process unit calculating a feature amount in advance desired for positive or negative determination of an audio command; and
an analysis processing unit carrying out a sound source separation process using the feature amount learned in the learning process unit.

8. The audio signal processing device according to claim 7, wherein the feature amount desired for the positive or negative determination of the audio command calculated in the learning process unit is a feature amount desired for a positive or negative determination process, which is a process of discriminating a target sound corresponding to the audio command executed in an audio command recognition process in the analysis processing unit from a non-target sound not corresponding to the audio command.

9. An audio signal processing method carrying out a command identification process from an input audio signal in an audio signal processing device, the method comprising:
time-frequency analyzing by a time-frequency analysis unit performing a time-frequency analysis of an input audio signal;
base factorizing by a base factorization unit inputting learning data that is generated in advance based on an audio signal for learning including a sound from a plurality of sound sources and is made with base frequencies corresponding to the respective sound sources and carrying out base factorization of a time-frequency analysis result to the input audio signal inputted from the time-frequency analysis unit by applying a total base frequency that has the base frequencies corresponding to the respective sound sources combined therein to generate a base activity to the input audio signal; and
command identifying by a command identification unit inputting the base activity generated in the base factorizing to carry out command identification by performing an identification process of the inputted base activity.

10. An audio signal processing method carrying out a command identification process from an input audio signal in an audio signal processing device, the method comprising:
learning processing by a learning process unit calculating a feature amount in advance desired for positive or negative determination of an audio command; and
analysis processing by an analysis processing unit carrying out a sound source separation process using the feature amount learned in the learning processing.

11. A program causing a command identification process from an input audio signal to be executed in an audio signal processing device, the program comprising:
time-frequency analyzing causing a time-frequency analysis unit to perform a time-frequency analysis of an input audio signal;
base factorizing causing a base factorization unit to input learning data that is generated in advance based on an audio signal for learning including a sound from a plurality of sound sources and is made with base frequencies corresponding to the respective sound sources and to carry out base factorization of a time-frequency analysis result to the input audio signal inputted from the time-frequency analysis unit by applying a total base frequency that has the base frequencies corresponding to the respective sound sources combined therein to generate a base activity to the input audio signal; and
command identifying causing a command identification unit to input the base activity generated in the base factorizing to carry out command identification by performing an identification process of the inputted base activity.
